(19) United States
(12) Patent Application Publication
(10) Pub. No.: US 2018/0089722 A1
(43) Pub. Date: Mar. 29, 2018

(54) SOCIAL MEDIA ADVERTISING SYSTEM AND METHOD

(71) Applicant: Justin Schulte, Urbandale, IA (US)

(72) Inventor: Justin Schulte, Urbandale, IA (US)

(21) Appl. No.: 15/711,047

(22) Filed: Sep. 21, 2017

Related U.S. Application Data
(60) Provisional application No. 62/399,532, filed on Sep. 26, 2016.

(51) Int. Cl. G06Q 30/02; G06Q 50/00; G06F 3/0482

(52) U.S. Cl. CPC G06Q 30/0277; G06F 3/0482; G06Q 50/01; G06Q 30/0251

(57) ABSTRACT

A social media advertising system facilitates the auto-population of a symbol, such as a sponsor's logo, in association with a topic or hashtag the sponsor has agreed to promote or support. The sponsor purchases the right to have a chosen symbol displayed when a social media post is published having a specific topic or hashtag. When the topic or hashtag goes viral or becomes a trending topic, the sponsor gets a large amount of exposure in association with a trendy or time sensitive topic. The sponsor can pay for this right by a per use fee, a fee for a predetermined amount of time, or by any other metric. The subtle display of a symbol in this manner does not distract from the purpose or content of the post. The symbol may also serve as an interactive hyperlink to content or a website chosen by the sponsor.

### CROSS REFERENCE TO RELATED APPLICATIONS

This application claims priority to U.S. Patent and Trademark Office Provisional Application No. 62/399,532 which was filed on Sep. 26, 2016 which contents are incorporated by reference herein.

### FIELD OF THE INVENTION

This invention relates to social media. More specifically and without limitation this invention relates to a social media advertising system and method.

### BACKGROUND OF THE INVENTION

Since the mass adoption of the internet the use of social media and social media platforms has exploded. Popular social media platforms include Facebook, Instagram, Myspace, LinkedIn, Snap Chat, YouTube and Twitter, among countless others.

Each social media platform has its own unique set of benefits and value proposition. Each social media platform also has its own unique set of constraints and limitations. What is ubiquitous to all social media platforms is the desire and need to monetize the activity that occurs on the social media platform. However, monetizing the activity on social media platforms has been difficult for many social media companies.

As one example, Twitter is one of the most popular social media platforms. However, Twitter has famously failed to adequately monetize its social media platform.

Twitter is an online social networking service that enables users to send and read short 140-character messages called “tweets”. Registered users can read and post tweets, but those who are unregistered can only read them. Users access Twitter through the website interface, SMS or a mobile device app.

Tweets are publicly visible by default, but senders can restrict message delivery to just their followers, users or groups. Users can tweet via the Twitter website, compatible external applications (apps), or by Short Message Service (SMS). Users may subscribe to other users' tweets—this is known as “following” and subscribers are known as “followers” or “tweeps”, a portmanteau of Twitter and peeps. Individual tweets can be forwarded by other users to their own feed, a process known as a “retweet”. Users can also “like” (formerly “favorite”) individual tweets. Twitter allows users to update their profile via their mobile phone either by text messaging or by apps.

As a social network, Twitter revolves around the principle of followers. When a user chooses to follow another Twitter user that user's tweets appear in reverse chronological order on their main Twitter page. If a user chooses to follow 20 people, they'll see tweets from all of these 20 people.

Users can group posts together by topic or type by use of hashtags—words or phrases prefixed with a “#” sign. Similarly, the “@” sign followed by a username is used for mentioning or replying to other users. To repost a message from another Twitter user and share it with one's own followers, a user can click the retweet button within the Tweet.

Tweets were set to a largely constrictive 140-character limit for compatibility with SMS messaging, introducing the shorthand notation and slang commonly used in SMS messages. The 140-character limit also increased the usage of URL shortening services such as bit.ly, goo.gl, and tr.im, and content-hosting services, such as Twitpic, memozu.com and NotePub to accommodate multimedia content and text longer than 140 characters. Since June 2011, Twitter has used its own t.co domain for automatic shortening of all URLs posted on its website, making other link shorteners superfluous for staying within the 140 character limit.

On May 24, 2016, Twitter announced that media such as photos and videos, and the person's handle, would not count against the 140 character limit. A user photo post used to count for about 24 characters. Attachments and links are also no longer be part of the character limit.

On Twitter, a word, phrase or topic that is mentioned at a greater or increasing rate than others is said to be a “trending topic”. Trending topics become popular either through a concerted effort by users, or because of an event that prompts people to talk about a specific topic. These topics help Twitter and their users to understand what is happening in the world and what people's opinions are about it. The Twitter web interface displays a list of trending topics on a sidebar on the home page, along with sponsored content. By clicking on any of the trending topics a user can see the tweets associated with that trending topic.

It has been reported that in the second quarter of 2016 that Twitter averaged 313 million monthly active users. At the present time, on average every second around 6,000 tweets are tweeted on Twitter, which corresponds to over 350,000 tweets sent per minute, 500 million tweets per day and around 200 billion tweets per year.

Despite this powerful platform and the immense numbers, Twitter has failed to adequately monetize its social media platform which has caused the stock to plummet from an all-time high of over $70/share to below $14/share recently. Recently it has been reported that Twitter is under talks to sell itself to another entity, due in-part to Twitter's inability to monetize its platform.

At this time, Twitter appears to have no answers as to how to monetize its social media platform. Increasing its advertising revenue has long been a topic of discussion and an area of interest for Twitter. However Twitter has been at a loss for how to increase its advertising revenue and harness its social media platform without perverting the experience or taking away from the content.

While the discussion above has used Twitter as an example, increasing advertising revenue and maximizing the monetization of a social media's user base and content is of interest to all social media companies and social media platforms.

Thus, it is a primary object of the invention to provide a social media advertising system and method that improves upon the state of the art.

Another object of the invention is to provide a social media advertising system and method that is easy to use.

Yet another object of the invention is to provide a social media advertising system and method that advertisers and users like.

Another object of the invention is to provide a social media advertising system and method that is subtle but effective.

Yet another object of the invention is to provide a social media advertising system and method that does not distract from the content or purpose of the social media platform.

Another object of the invention is to provide a social media advertising system and method that is easy to implement.

Yet another object of the invention is to provide a social media advertising system and method that increases revenues.

Another object of the invention is to provide a social media advertising system and method that is aesthetically pleasing.

Yet another object of the invention is to provide a social media advertising system and method that provides further information regarding the advertiser.

Another object of the invention is to provide a social media advertising system and method that helps to harness the power of social networks.

Yet another object of the invention is to provide a social media advertising system and method that is inexpensive to use or implement.

Another object of the invention is to provide a social media advertising system and method that provides results.

Yet another object of the invention is to provide a social media advertising system and method that does not inconvenience the user, which may be the person making the post or the person viewing the post.

Another object of the invention is to provide a social media advertising system and method that is easy to implement for the advertiser.

Yet another object of the invention is to provide a social media advertising system and method that provides value, utility and novelty.

These and other objects, features, or advantages of the invention will become apparent from the specification, claims and drawings.

### SUMMARY OF THE INVENTION

A social media advertising system facilitates the auto-population of a symbol, such as a sponsor's logo, in association with a topic or hashtag the sponsor has agreed to promote or support. The sponsor purchases the right to have a chosen symbol displayed when a social media post is published having a specific topic or hashtag. When the topic or hashtag goes viral or becomes a trending topic, the sponsor gets a large amount of exposure in association with a trendy or time sensitive topic. The sponsor can pay for this right by a per use fee, a fee for a predetermined amount of time, or by any other metric. The subtle display of a symbol in this manner does not distract from the purpose or content of the post. If the user is interested in learning more from the sponsor, the symbol may also serve as an interactive hyperlink that when clicked upon takes the user to content or a website chosen by the sponsor. This system provides a new revenue stream for social media platforms.

### BRIEF DESCRIPTION OF THE DRAWINGS

FIG. 1 is a plan view a social media advertising system, the view showing a user connecting to a social media platform of a social media company through a computer or handheld device over an electronic network, the social media platform having a website, an algorithm and an application, a social media post posted on the social media platform having content, a hashtag and a topic, a database and marketing firm connected to the social media platform over the electronic network, a viewer connected to the social media platform over the electronic network;

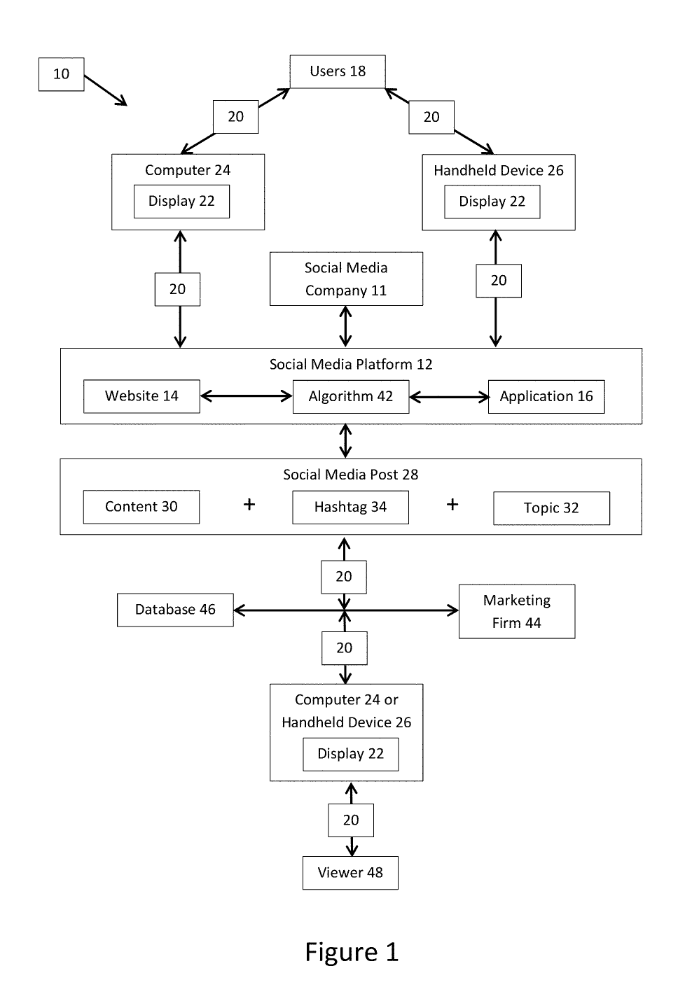

FIG. 2 is a plan view a social media advertising system, the view showing a plan view of a screen show of a website of the social media platform the view showing a social media post having hashtag, a topic and a symbol of a sponsor positioned after the hashtag and the topic; the view also showing a trending topic list including a plurality of hashtags and topics, with one of the topics having the symbol of a sponsor positioned after the topic and hashtag and topic; in this example, the social media post includes #internationaldayofpeace with the Audi logo positioned after the hashtag;

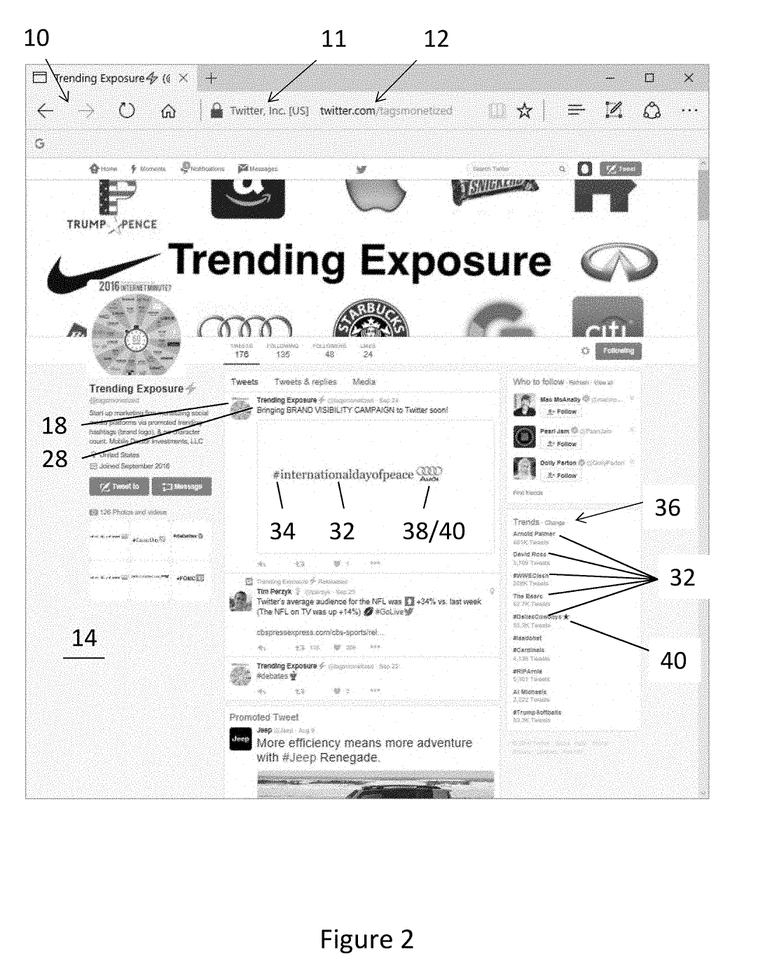

FIG. 3 is a plan view a social media advertising system, the view showing a plan view of a screen show of a website of the social media platform the view showing a social media post having hashtag, a topic and a symbol of a sponsor positioned after the hashtag and the topic; in this example, the social media post includes #TerribleDebateQuestions with the Budweiser logo positioned after the hashtag, #FOMC with the TD Ameritrade logo positioned after the hashtag, and #EMMYS with the ABD logo positioned after the hashtag;

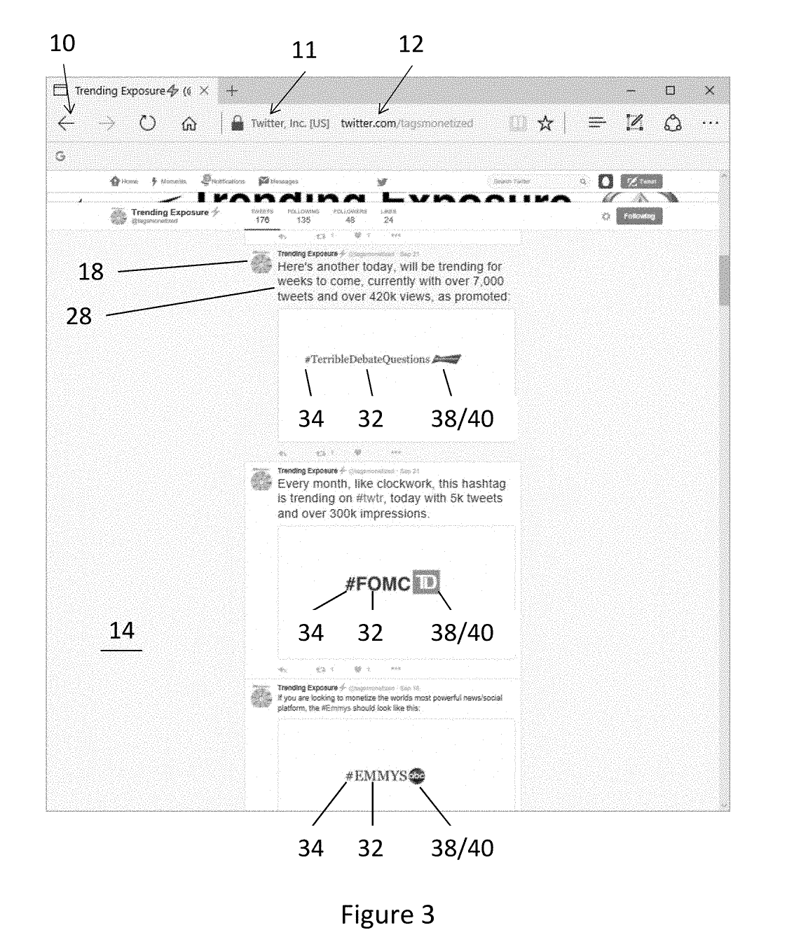

FIG. 4 is a plan view a social media advertising system, the view showing a plan view of a screen show of a website of the social media platform the view showing a social media post having hashtag, a topic and a symbol of a sponsor positioned after the hashtag and the topic; in this example, the social media post includes #WATMUN with the BMW logo positioned after the hashtag;

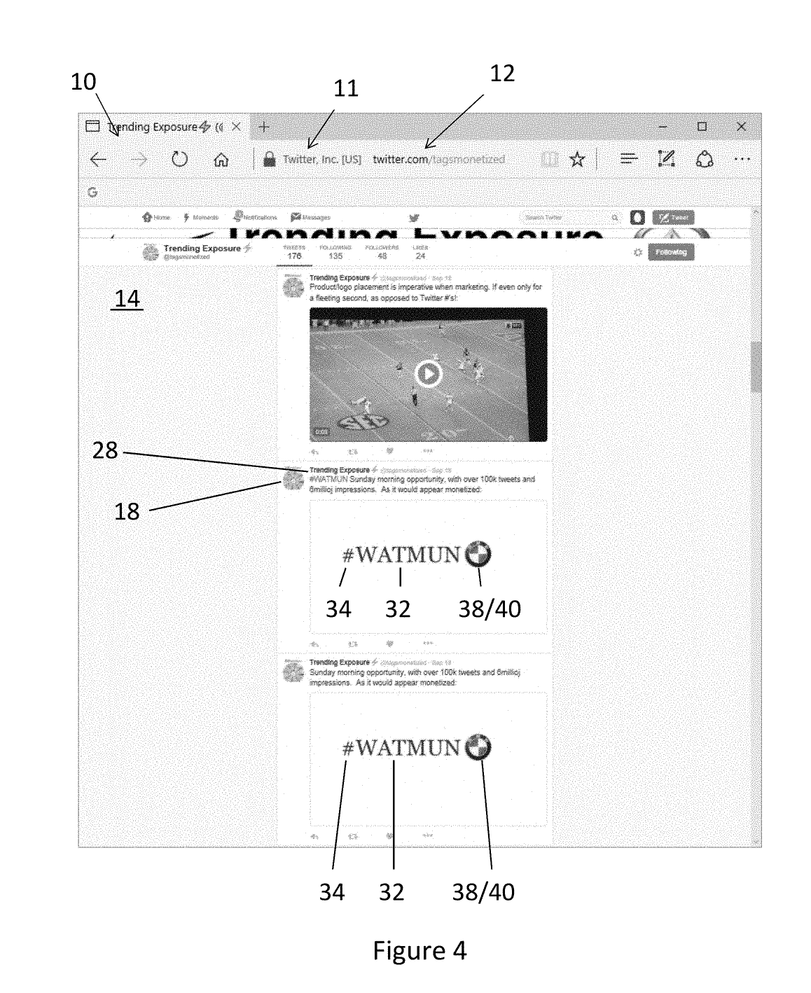

FIG. 5 is a plan view a social media advertising system, the view showing a plan view of a screen show of a website of the social media platform the view showing a social media post having hashtag, a topic and a symbol of a sponsor positioned after the hashtag and the topic; in this example, the social media post includes #BatManDay with the Uber logo positioned after the hashtag;

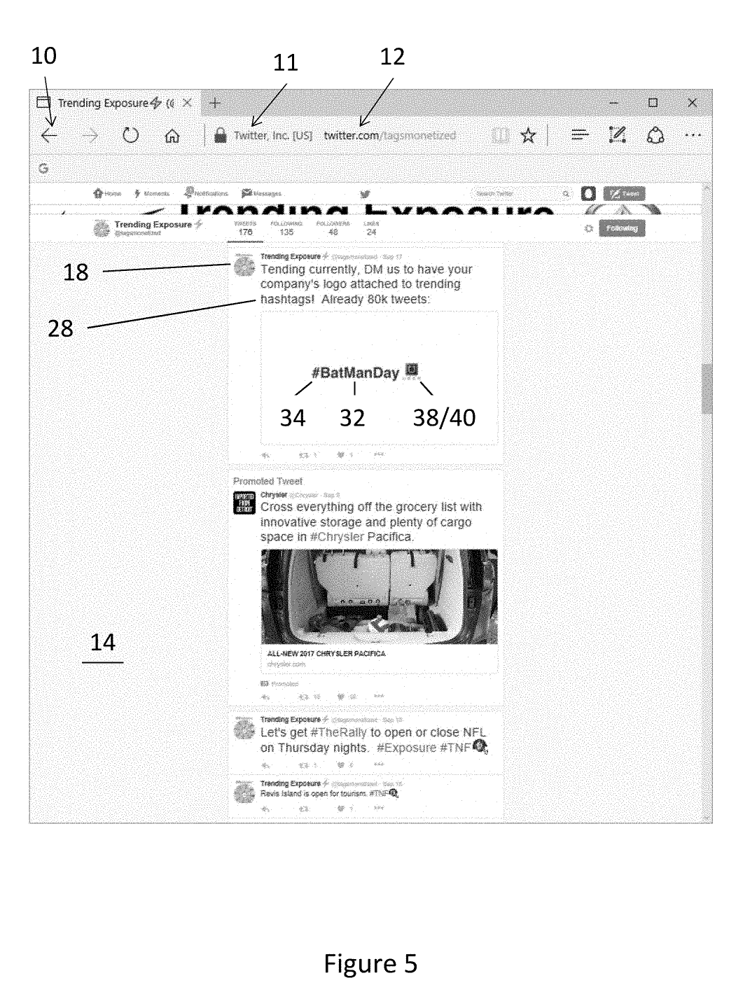

FIG. 6 is a plan view a social media advertising system, the view showing a plan view of a screen show of a website of the social media platform the view showing a social media post having hashtag, a topic and a symbol of a sponsor positioned after the hashtag and the topic; in this example, the social media post includes #NYJvsBUF with the Pizza Hut logo positioned after the hashtag, #TheRally with the Pizza Hut logo positioned after the hashtag;

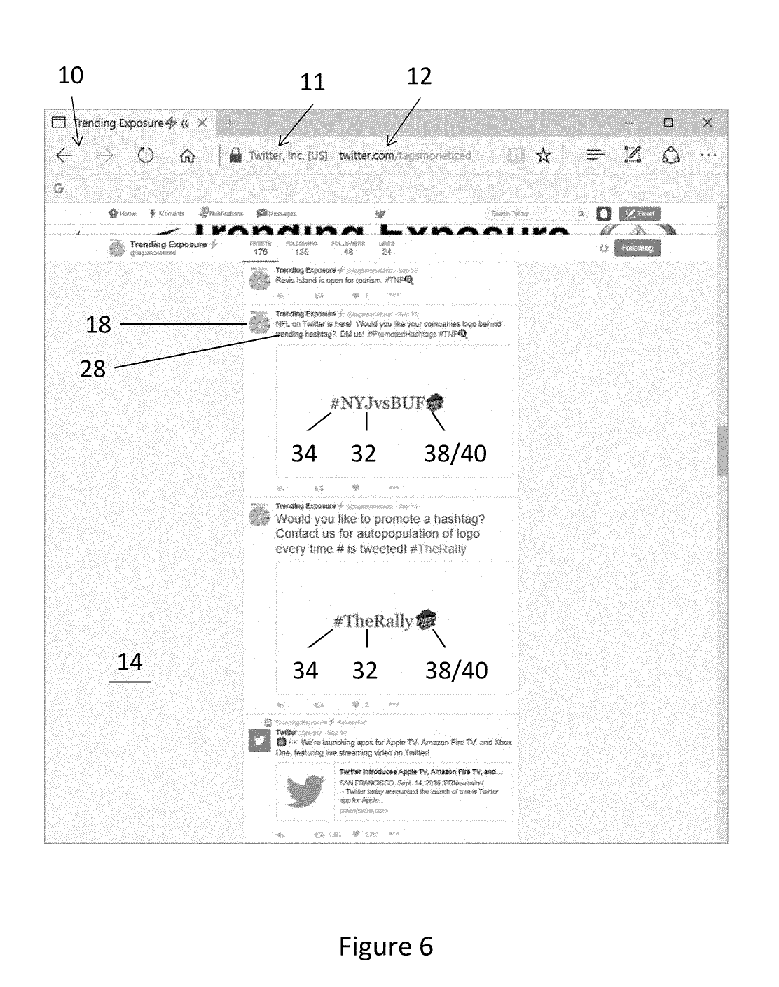

FIG. 7 is a plan view a social media advertising system, the view showing a plan view of a screen show of a website of the social media platform the view showing a social media post having hashtag, a topic and a symbol of a sponsor positioned after the hashtag and the topic; in this example, the social media post includes #iOS10 with the Pokémon logo positioned after the hashtag;

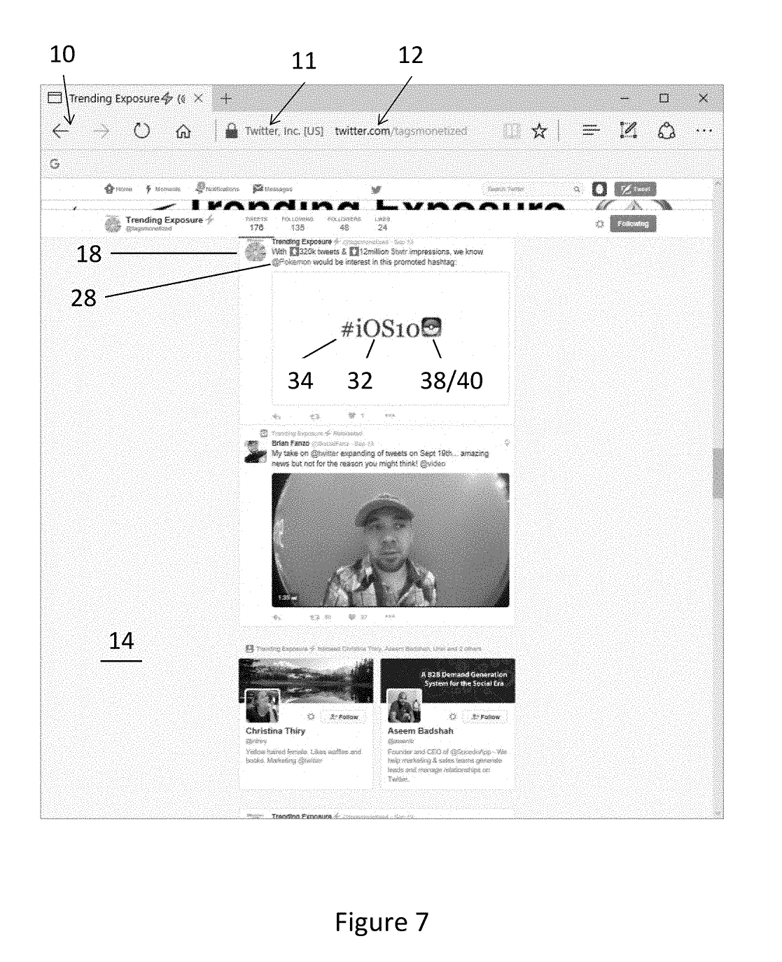

FIG. 8 is a plan view a social media advertising system, the view showing a plan view of a screen show of a website of the social media platform the view showing a social media post having hashtag, a topic and a symbol of a sponsor positioned after the hashtag and the topic; in this example, the social media post includes #NationalVideoGamesDay with the Playstation logo positioned after the hashtag;

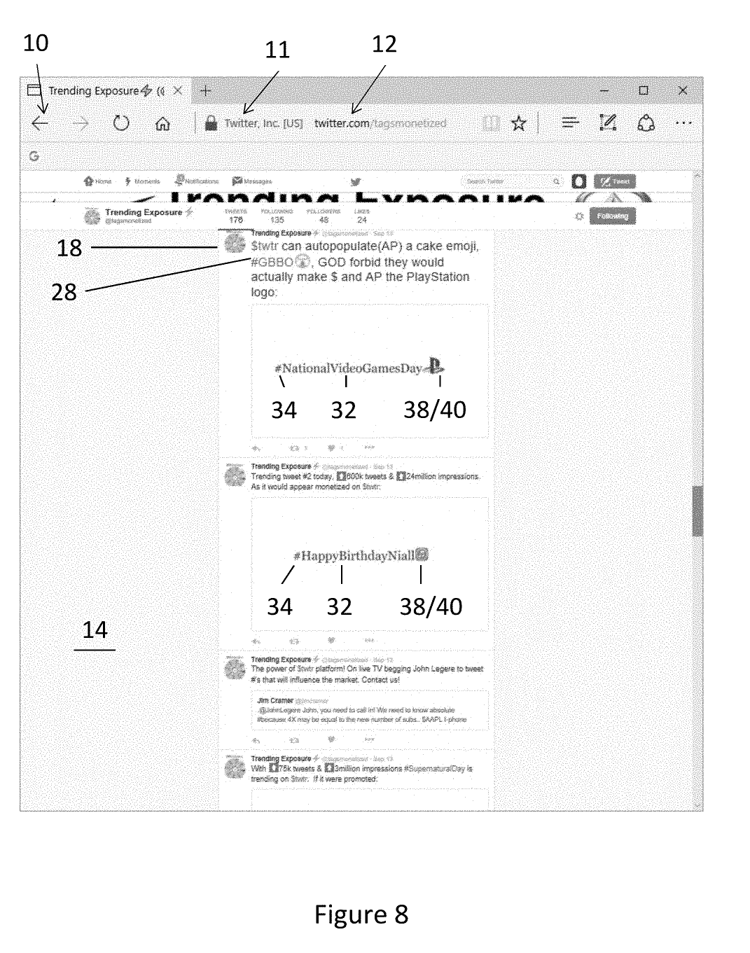

FIG. 9 is a plan view a social media advertising system, the view showing a plan view of a screen show of a website of the social media platform the view showing a social media post having hashtag, a topic and a symbol of a sponsor positioned after the hashtag and the topic; in this example, the social media post includes #SupernaturalDay with the CW logo positioned after the hashtag, #UFC203 with the Infinity logo positioned after the hashtag;

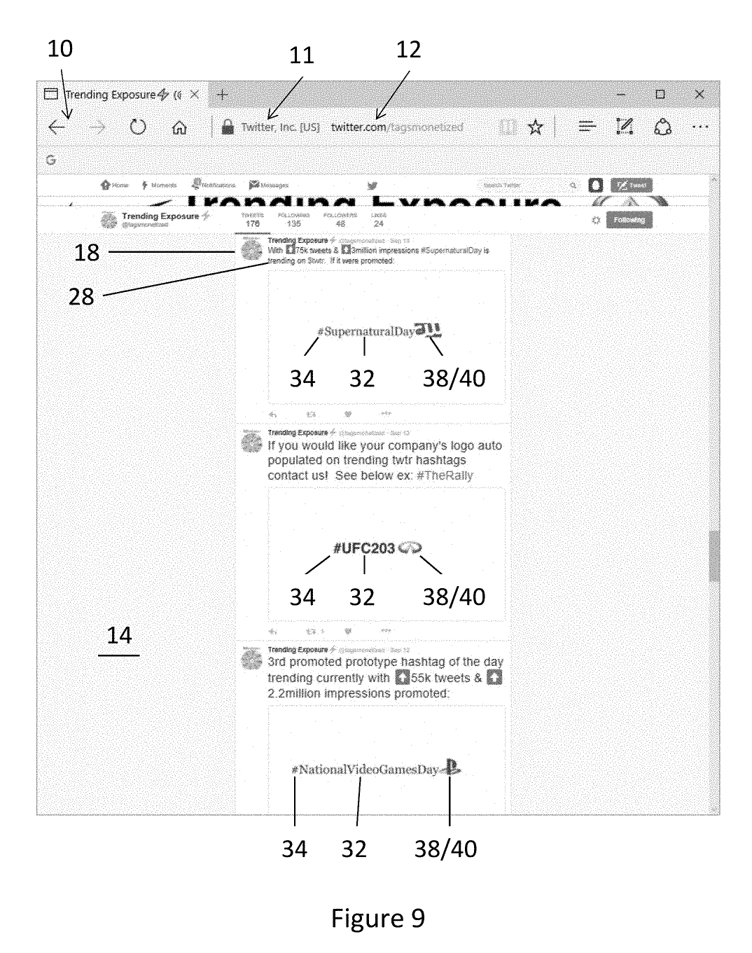

FIG. 10 is a plan view a social media advertising system, the view showing a plan view of a screen show of a website of the social media platform the view showing a social media post having hashtag, a topic and a symbol of a sponsor positioned after the hashtag and the topic; in this example, the social media post includes #PrayForKorea with the Samsung logo positioned after the hashtag, #mondaymotivation with the TD Ameritrade logo positioned after the hashtag;

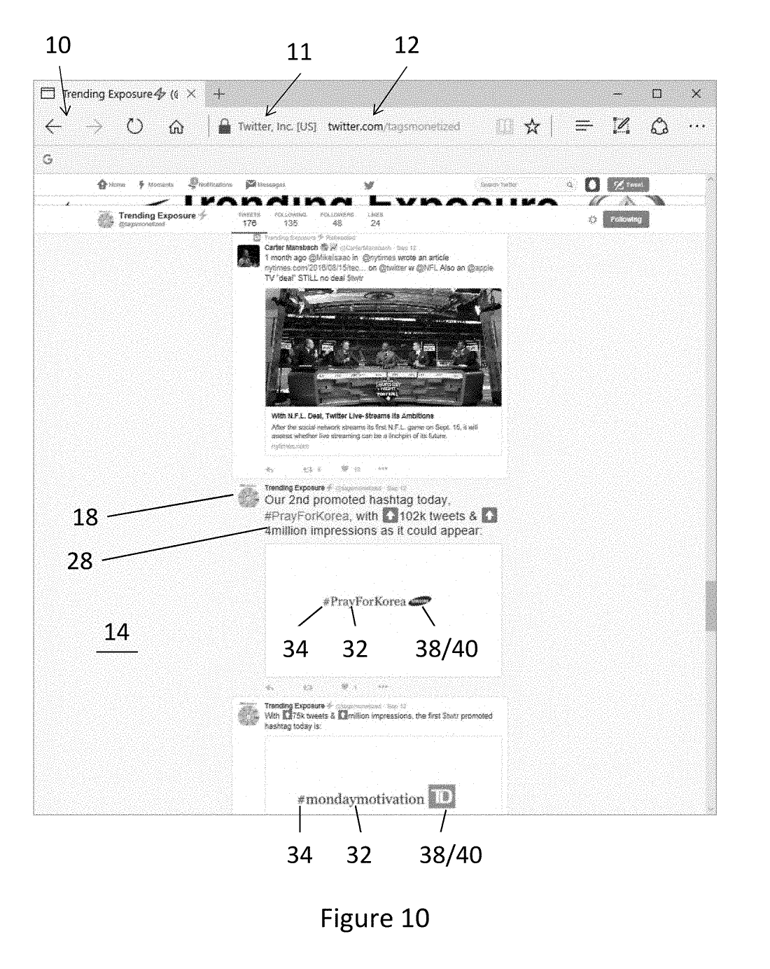

FIG. 11 is a plan view a social media advertising system, the view showing a plan view of a screen show of a website of the social media platform the view showing a social media post having hashtag, a topic and a symbol of a sponsor positioned after the hashtag and the topic; in this example, the social media post includes #WWEBacklash with the Miller Lite logo positioned after the hashtag;

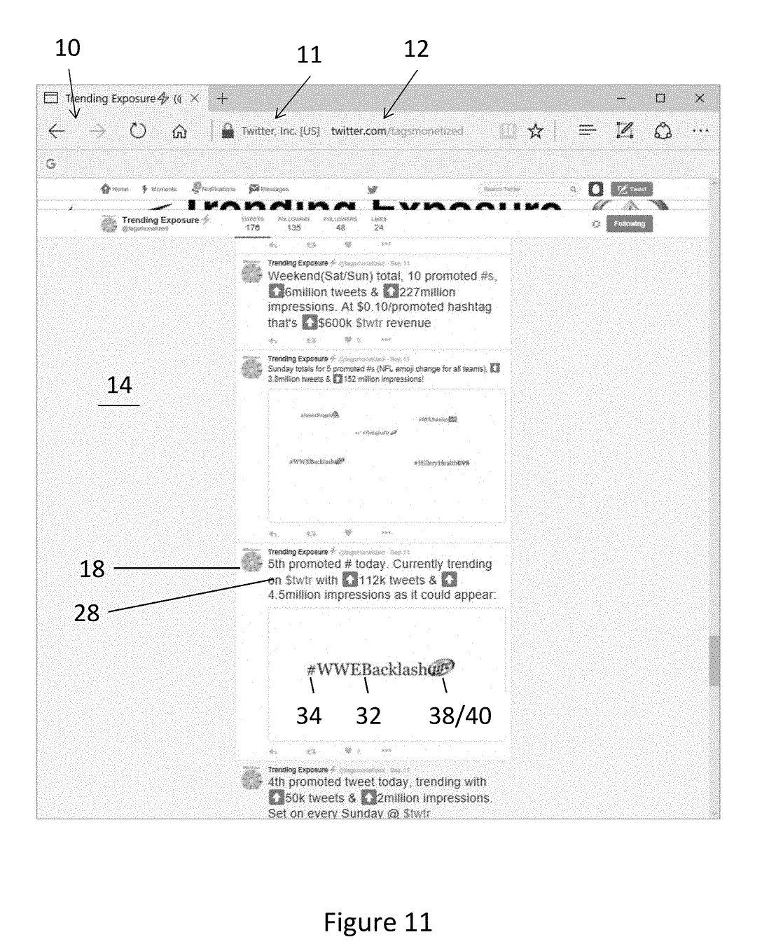

FIG. 12 is a plan view a social media advertising system, the view showing a plan view of a screen show of a website of the social media platform the view showing a social media post having hashtag, a topic and a symbol of a sponsor positioned after the hashtag and the topic; in this example, the social media post includes #NFLSunday with the Pepsi logo positioned after the hashtag, #HillaryHealth with the CVS logo positioned after the hashtag, and #FlyEaglesFly with the Nike logo positioned before the hashtag and the Eagles logo positioned after the hashtag;

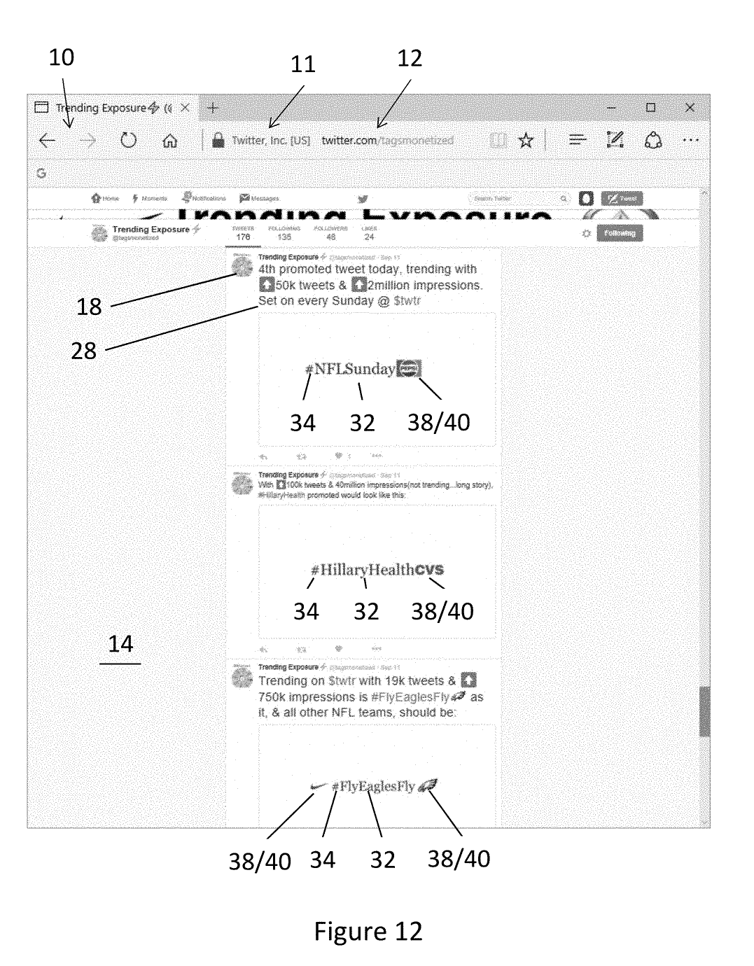

FIG. 13 is a plan view a social media advertising system, the view showing a plan view of a screen show of a website of the social media platform the view showing a social media post having hashtag, a topic and a symbol of a sponsor positioned after the hashtag and the topic; in this example, the social media post includes #NeverForget with the American Airlines logo positioned after the hashtag;

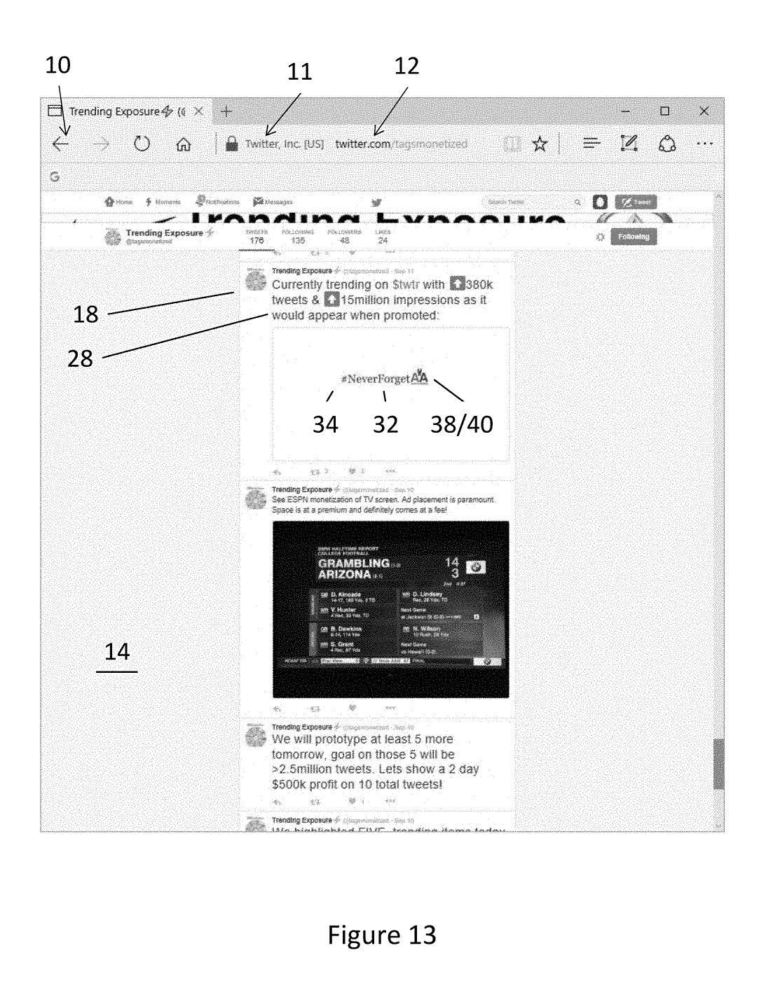

FIG. 14 is a plan view a social media advertising system, the view showing a plan view of a screen show of a website of the social media platform the view showing a social media post having hashtag, a topic and a symbol of a sponsor positioned after the hashtag and the topic; in this example, the social media post includes #PennState with the Nile logo positioned after the hashtag;

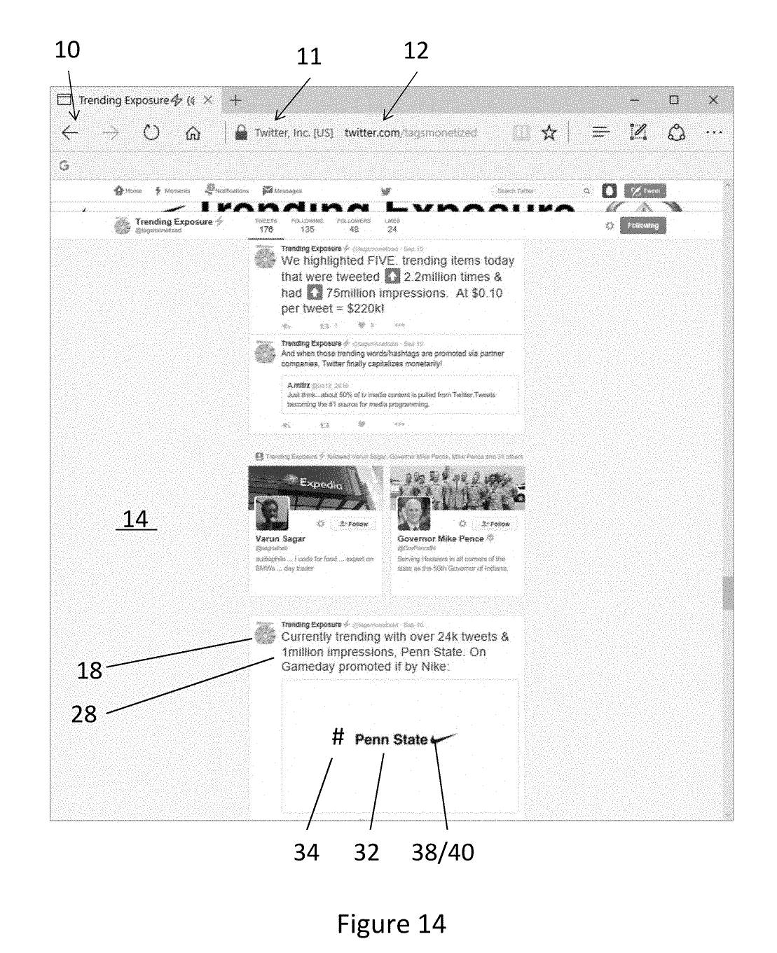

FIG. 15 is a plan view a social media advertising system, the view showing a plan view of a screen show of a website of the social media platform the view showing a social media post having hashtag, a topic and a symbol of a sponsor positioned after the hashtag and the topic; in this example, the social media post includes #BasketOfDeplorables with the Hilary Clinton logo positioned after the hashtag;

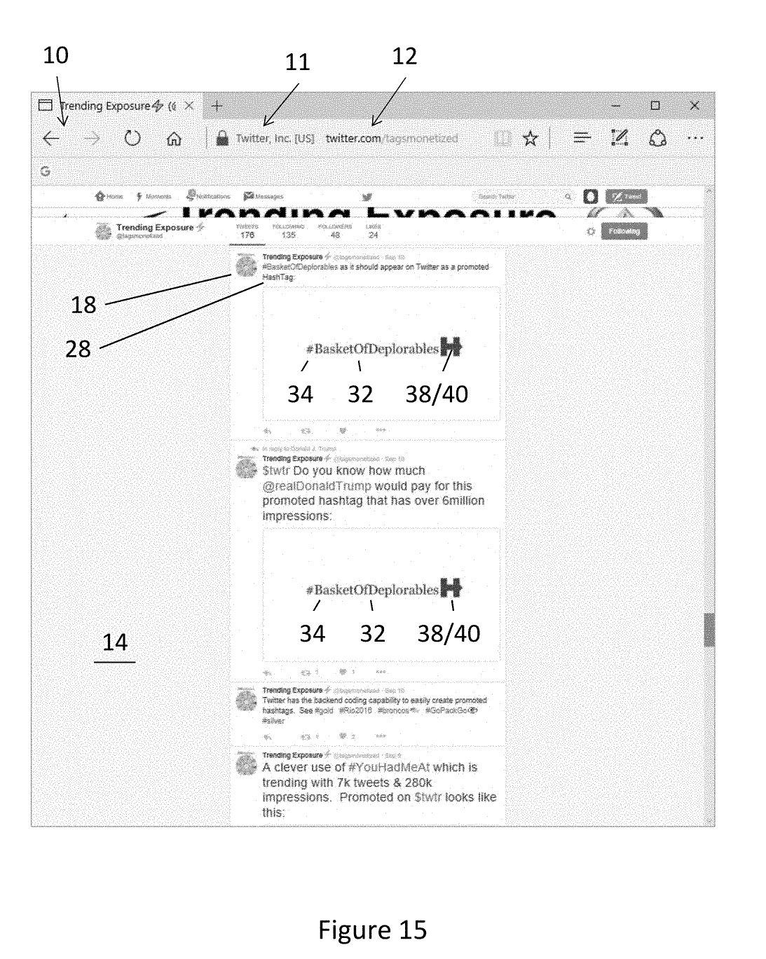

FIG. 16 is a plan view a social media advertising system, the view showing a plan view of a screen show of a website of the social media platform the view showing a social media post having hashtag, a topic and a symbol of a sponsor positioned after the hashtag and the topic; in this example, the social media post includes #YouHadMeAt with the Snickers logo positioned after the hashtag, and #KeepPounding with the Nike logo positioned before the hashtag and the Carolina Panthers logo positioned after the hashtag;

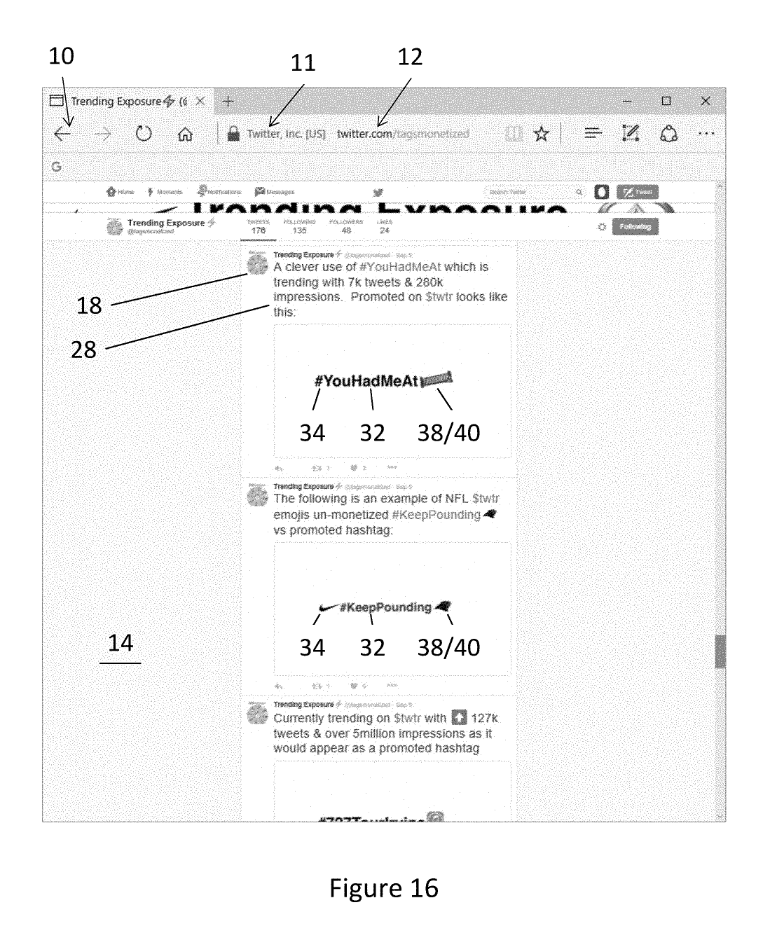

FIG. 17 is a plan view a social media advertising system, the view showing a plan view of a screen show of a website of the social media platform the view showing a social media post having hashtag, a topic and a symbol of a sponsor positioned after the hashtag and the topic; in this example, the social media post includes #727TourIrvine with a music app logo positioned after the hashtag, and #IOWAvsISU with the Hy-Vee logo positioned after the hashtag;

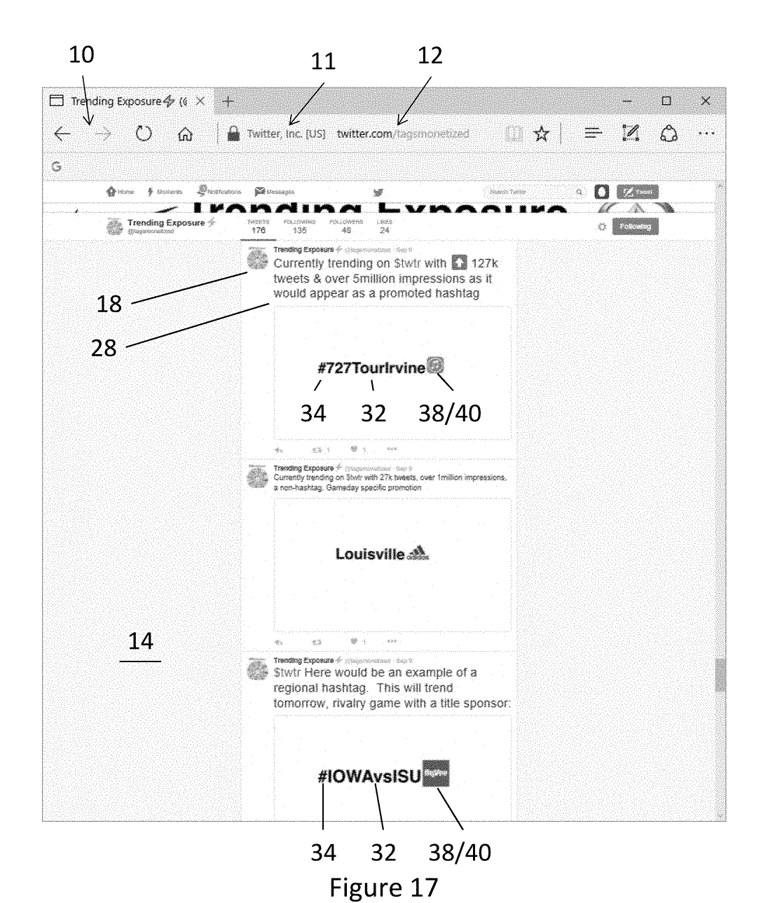

FIG. 18 is a plan view a social media advertising system, the view showing a plan view of a screen show of a website of the social media platform the view showing a social media post having hashtag, a topic and a symbol of a sponsor positioned after the hashtag and the topic; in this example, the social media post includes #MakeAMovieMoreCanadian with a Canadian promotion logo positioned after the hashtag, and #FridayFeeling with the Friday's logo positioned after the hashtag;

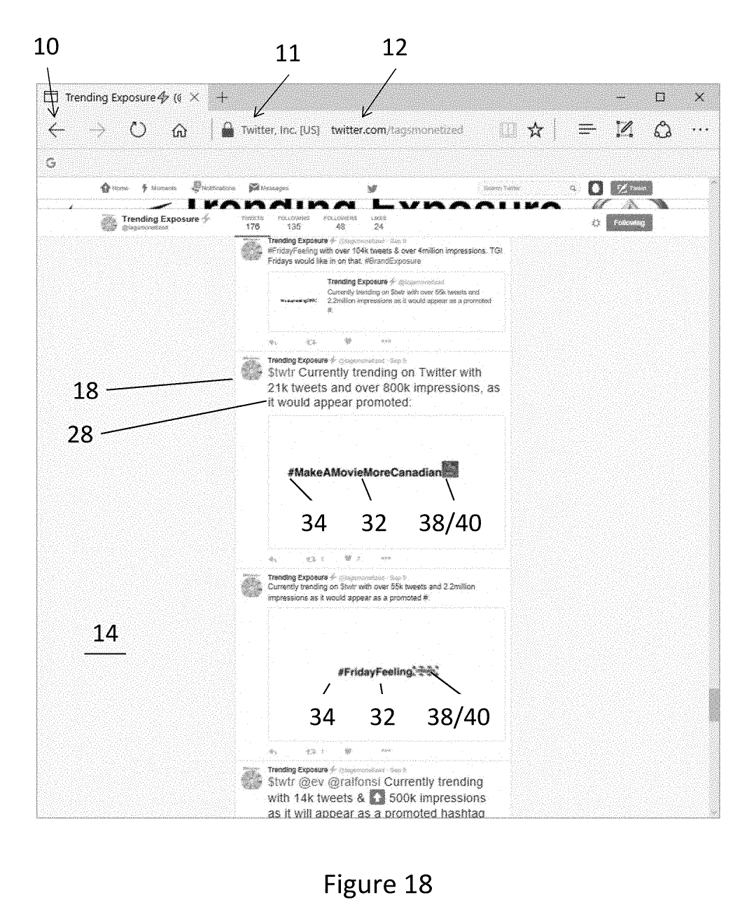

FIG. 19 is a plan view a social media advertising system, the view showing a plan view of a screen show of a website of the social media platform the view showing a social media post having hashtag, a topic and a symbol of a sponsor positioned after the hashtag and the topic; in this example, the social media post includes #iPhone7PreOrder with the Apple logo positioned after the hashtag, and #CARvsDEN with a beverage logo positioned after the hashtag;

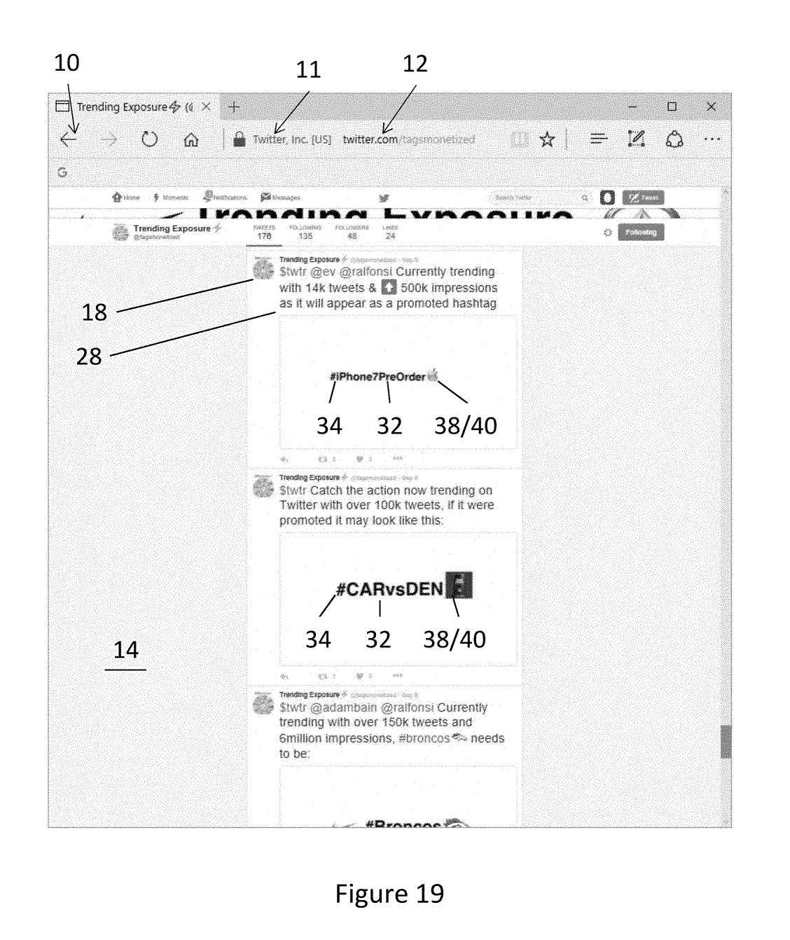

FIG. 20 is a plan view a social media advertising system, the view showing a plan view of a screen show of a website of the social media platform the view showing a social media post having hashtag, a topic and a symbol of a sponsor positioned after the hashtag and the topic; in this example, the social media post includes #Broncos with the Nike logo positioned before the hashtag and the Broncos logo positioned after the hashtag, #NFLonTwitter with a Pepsi logo positioned after the hashtag and #NFLKickoff with a Papa John's logo positioned after the hashtag;

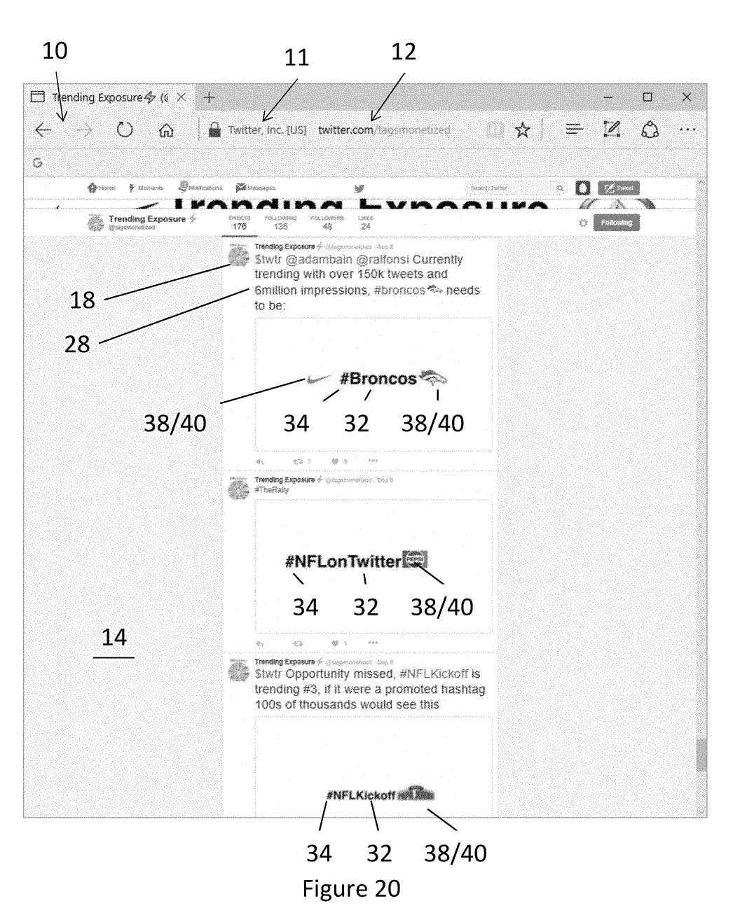

FIG. 21 is a plan view a social media advertising system, the view showing a plan view of a screen show of a website of the social media platform the view showing a social media post having hashtag, a topic and a symbol of a sponsor positioned after the hashtag and the topic; in this example, the social media post includes #MakeAMovieCaffeinated with a Starbucks logo positioned after the hashtag and #Gala1GH17 with an Amazon logo positioned after the hashtag;

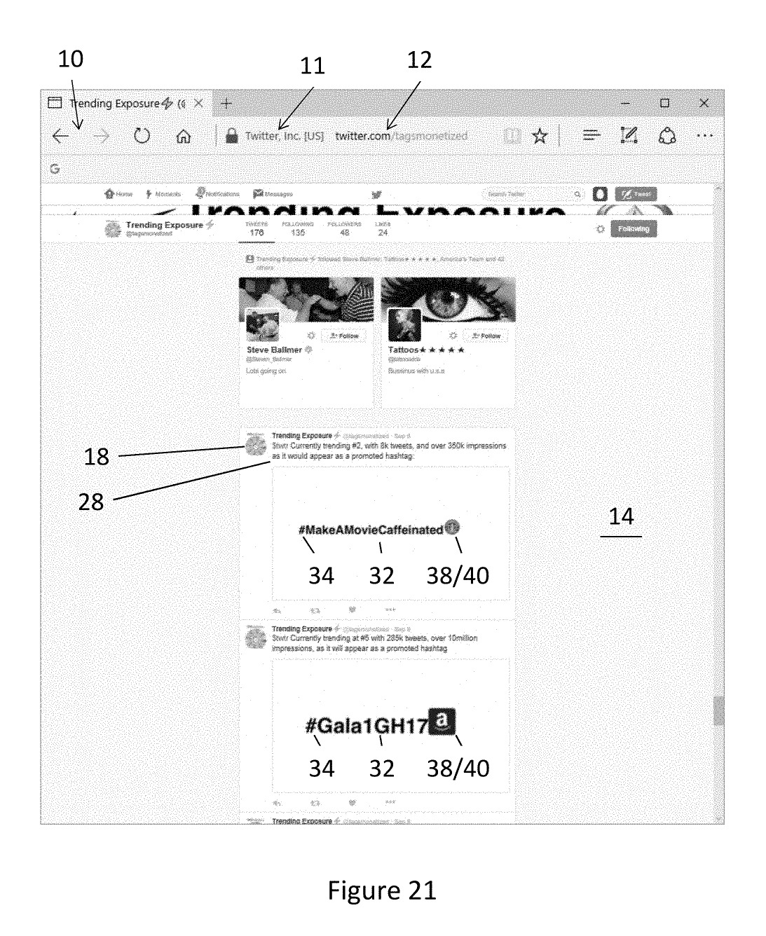

FIG. 22 is a plan view a social media advertising system, the view showing a plan view of a screen show of a website of the social media platform the view showing a social media post having hashtag, a topic and a symbol of a sponsor positioned after the hashtag and the topic; in this example, the social media post includes #ThursdayThoughts with the Pinterest logo positioned after the hashtag, #StarTrek50 with a Google logo positioned after the hashtag and #Debate with an BMW logo positioned after the hashtag;

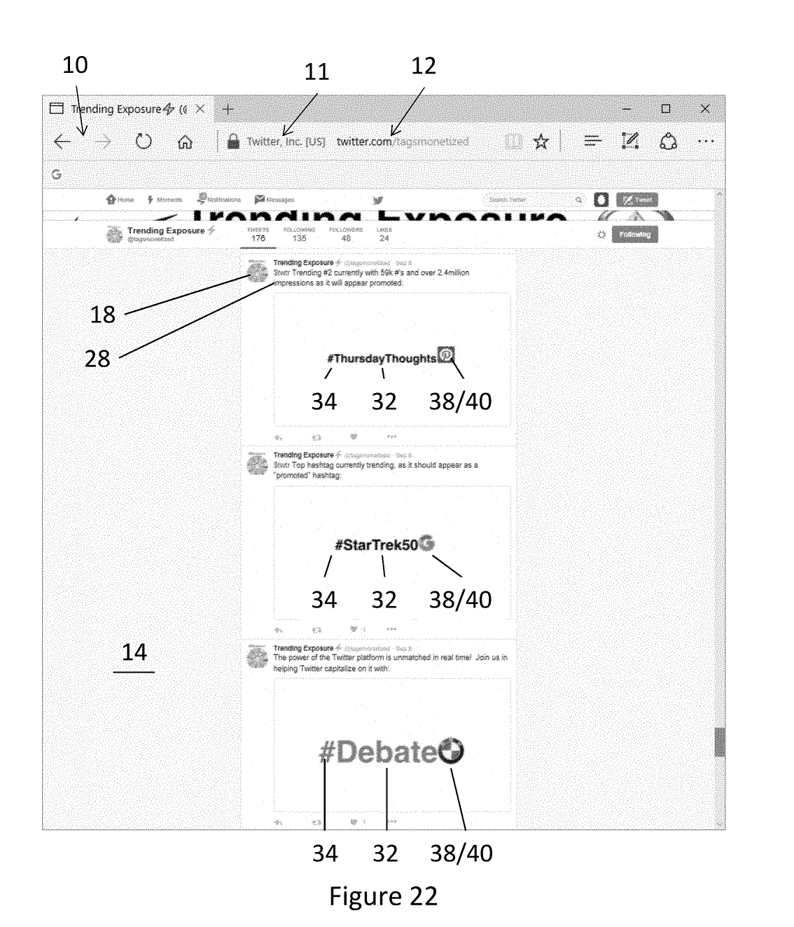

FIG. 23 is a plan view a social media advertising system, the view showing a plan view of a screen show of a website of the social media platform the view showing a social media post having hashtag, a topic and a symbol of a sponsor positioned after the hashtag and the topic; in this example, the social media post includes #HurricaneMadeine with the ServePro logo positioned after the hashtag, and #MISSvsFSU with a Pepsi logo positioned after the hashtag;

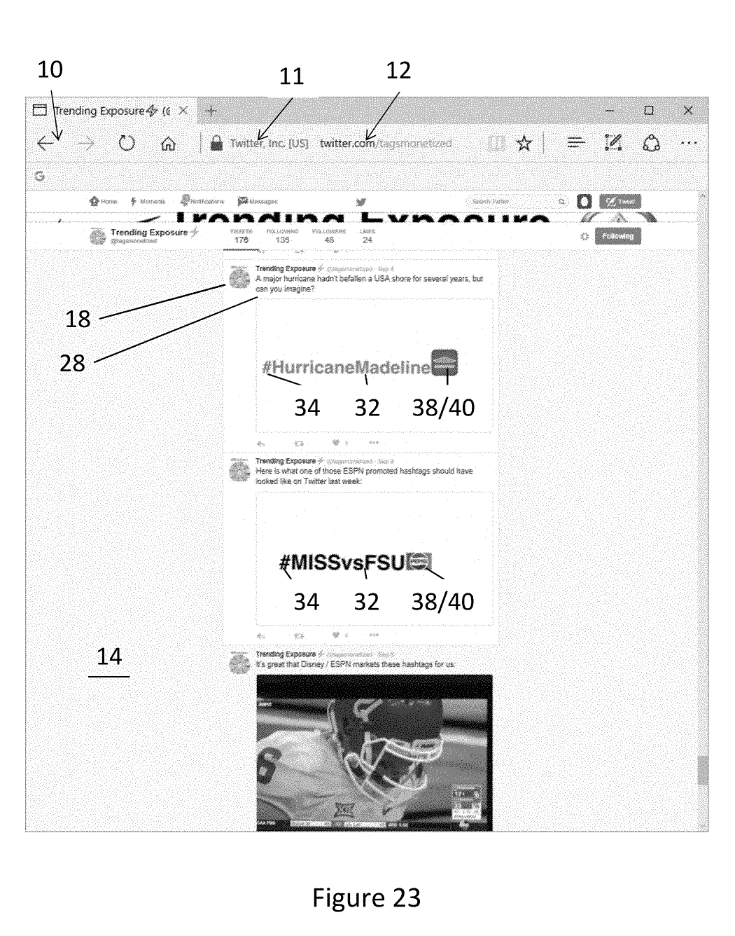

FIG. 24 is a plan view a social media advertising system, the view showing a plan view of a screen show of a website of the social media platform the view showing a social media post having hashtag, a topic and a symbol of a sponsor positioned after the hashtag and the topic; in this example, the social media post includes #GameDay with the Home Depot logo positioned after the hashtag, and #Earthquake with a Allstate logo positioned after the hashtag;

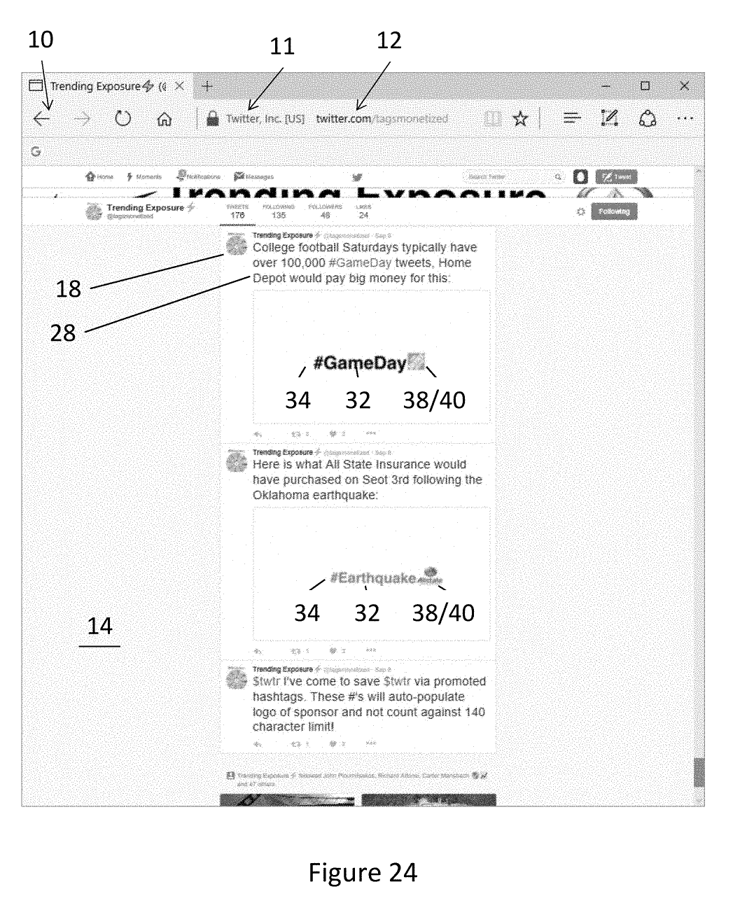

FIG. 25 is a plan view a social media advertising system, the view showing a plan view of a screen show of an app of the social media platform the view showing a social media post having hashtag, a topic and a symbol of a sponsor positioned after the hashtag and the topic; in this example, the social media post includes #Debates with the Google logo positioned after the hashtag;

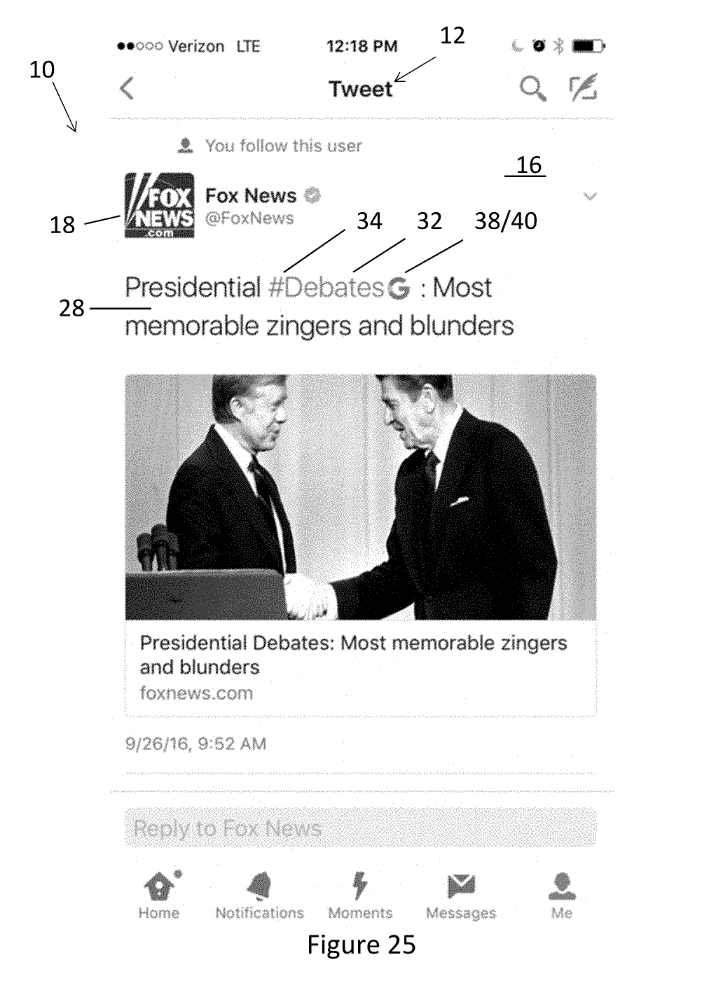

FIG. 26 is a plan view a social media advertising system, the view showing a plan view of a screen show of an app of the social media platform the view showing a social media post having hashtag, a topic and a symbol of a sponsor positioned after the hashtag and the topic; in this example, the social media post includes #BlackFriday with the Best Buy logo positioned after the hashtag;

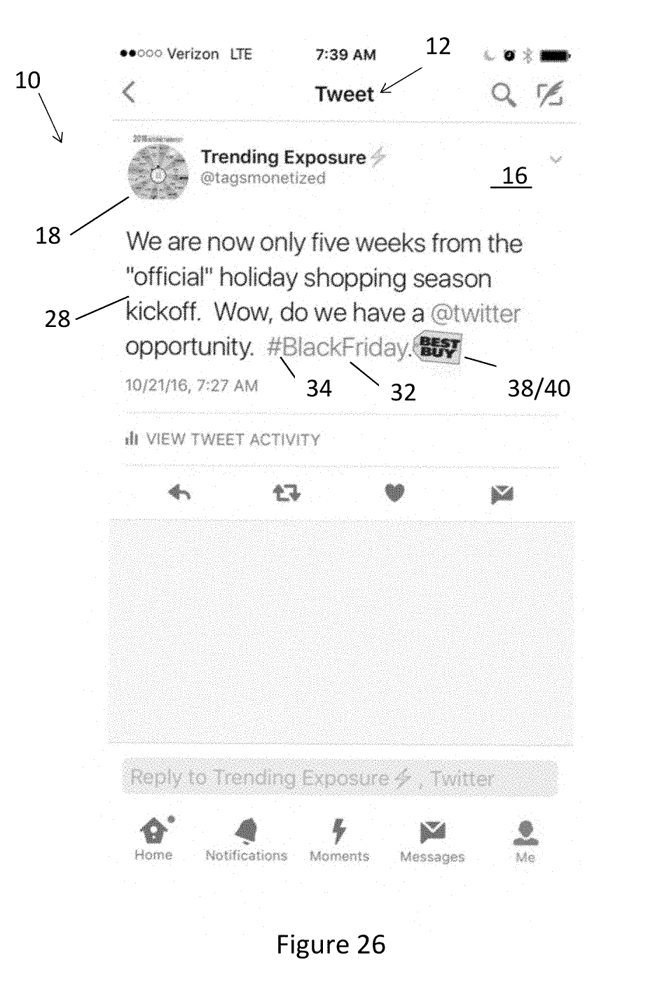

FIG. 27 is a plan view a social media advertising system, the view showing a plan view of a screen show of an app of the social media platform the view showing a trending topic list with a plurality of trending topics having a hashtag, a topic and a symbol of a sponsor positioned after the hashtag and the topic; in this example, the trending topic list includes #Huskers with the Adidas logo positioned after the hashtag, #SundayMorning with the Starbucks logo positioned after the hashtag, #NorthKoreaNukes with the CNN logo positioned after the hashtag;

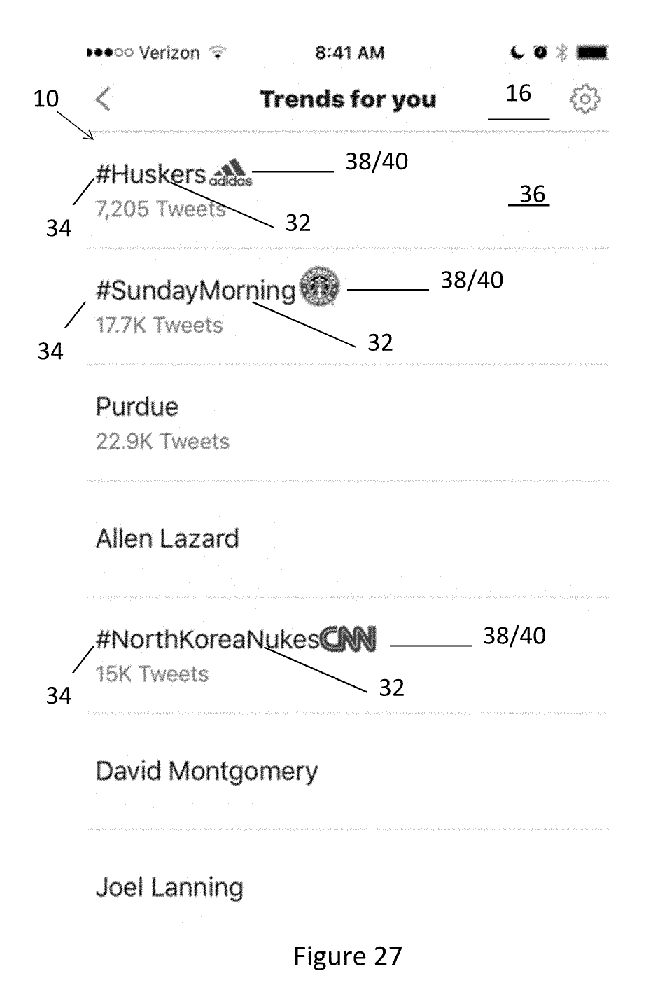

FIG. 28 is a plan view a social media advertising system, the view showing a plan view of a screen show of an app of the social media platform the view showing a social media post having hashtag, a topic and a symbol of a sponsor positioned after the hashtag and the topic; in this example, the social media post includes #Huskers with the Adidas logo positioned after the hashtag;

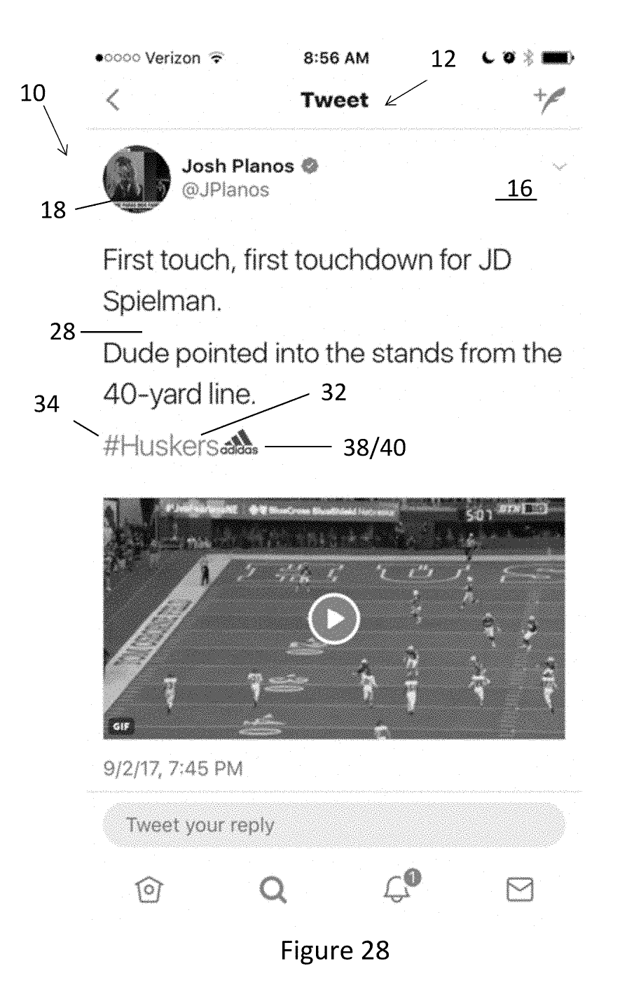

FIG. 29 is a plan view a social media advertising system, the view showing a plan view of a screen show of an app of the social media platform the view showing a social media post having hashtag, a topic and a symbol of a sponsor positioned after the hashtag and the topic; in this example, the social media post includes #GameDay with the Home Depot logo positioned after the hashtag.

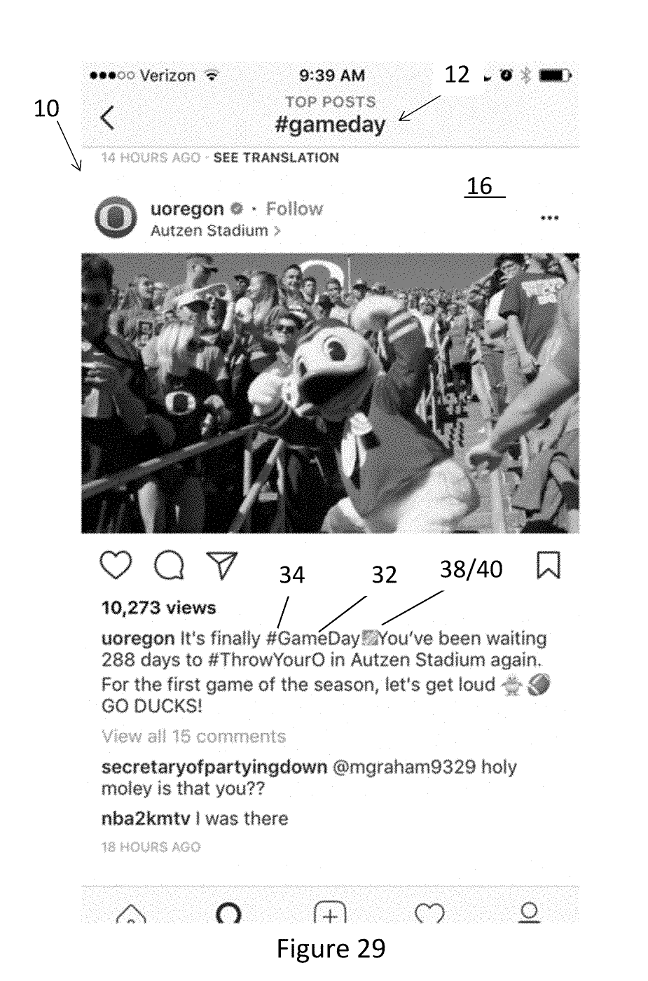

### DETAILED DESCRIPTION OF THE PREFERRED EMBODIMENT

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that mechanical, procedural, and other changes may be made without departing from the spirit and scope of the invention. The following detailed description is, therefore, not to be taken in a limiting sense, and the scope of the invention is defined only by the appended claims, along with the full scope of equivalents to which such claims are entitled.

As used herein, the terminology such as vertical, horizontal, top, bottom, front, back, end, sides, left, right and the like, are referenced according to the views presented. It should be understood, however, that the terms are used only for purposes of description, and are not intended to be used as limitations. Accordingly, orientation of an object or a combination of objects may change without departing from the scope of the invention.

In addition, while reference herein is primarily made to Twitter, this is only by way of example. The invention is not limited to use with Twitter. Instead, the system presented is hereby contemplated for use with any social media platform and it shall be understood that any reference to Twitter shall be construed as a reference to any social media platform.

System:

With reference to the figures, a social media advertising system 10 is presented. The system 10 includes the components including a social media platform 12 having a website 14 and/or application 16 that is accessible by users 18 over an electronic network 20, such as the internet, through a display 22 of a computer 24 and/or handheld device 26 such as a smartphone, tablet or the like. The system 10 also includes a social media post 28 having content 30, a hashtag 34 and a topic 32 that is viewable by a view 48 through electronic network 20. The system 10 also includes a database 46 and a marketing firm 44.

As an example, using Twitter as the social media platform 12, users 18 submit or publish a post 28 to the social media platform 12 that contains content 30 related to a topic 32. Content 30 most often includes text that provides information (such as an opinion, view point, facts, or any other information) but can also include images, videos, audio, emojis, links or any other information or content, including video, audio, animation and the like. Topic 32 that identifies what the content 28 relates to and can be any theme, subject, subject matter, issue, area, focus, point or any other topic or area of interest. In some arrangements, the user 18 includes a hashtag 34 in association with the topic 32 that identifies what the content 28 relates to. Hashtag 34 is any type of label or metadata tag used on the social media platform 12 which makes it easier for users 18 to find messages related to the topic 32 and for the social media platform 12 to track what topics 32 users 18 are posting about and what topics are currently of interest to users 18. Users 18 create and use hashtags 34 by placing the hash character (or pound sign) # (also known as the number sign or octothorpe) in front of a word or unspaced phrase (the topic 32), in any portion of post 28, such as at the beginning, embedded within the content 30, or at the end of the content 30. Searching for that hashtag 32 will then present each message that has been tagged with the hashtag 34. A hashtag archive is consequently collected into a single stream under the same hashtag 34. In one arrangement, social media platform 12 recognizes the presence of a hashtag 34 and automatically turns the hashtag 34 in the social media post 28 into an interactive link that when selected, such as by clicking or tapping, the social media platform 12 takes the user 18 to a search of social media posts 28 related to the hashtag 34.

To track the activity on the social media platform 12 and inform users 18 as to what other users 18 are discussing, popular topics 32 or hashtags 34 are identified by the social media platform 12 as a trending topic 32 and presented for display in a trending topic list 36. This trending topic list 36 displays the most active recent topics 32 and/or hashtags 34. When a user 18 selects any of the topics 32 or hashtags 34 in the trending topic list 36 the user 18 is presented with all posts 28 associated with that topic 32 or hashtag 34.

As examples:
When a post 28 includes “The Iowa State Cyclones are going to win today! #GameDay” the content 30 is “The Iowa State Cyclones are going to win today!”, the topic 32 is “game day” and “#” is the hashtag 34, or alternatively when the pound symbol is presented in front of the unspaced topic 28 “GameDay” this converts the entire text of “#GameDay” into the hashtag 34.
When a post 28 includes “Nothing is more important than peace! #InternationalDayofPeace” the content 30 is “Nothing is more important than peace!”, the topic 32 is “international day of peace” and “#” is the hashtag 34, or alternatively when the pound symbol is presented in front of the unspaced topic 28 “InternationalDayofPeace” this converts the entire text of “#InternationalDayofPeace” into the hashtag 34.
When a post 28 includes “#IOWAvsISU Iowa has no chance in this one!” the content 30 is “Iowa has no chance in this one!”, the topic 32 is “Iowa vs ISU” and “#” is the hashtag 34, or alternatively when the pound symbol is presented in front of the unspaced topic 28 “IOWAvsISU” this converts the entire text of “#IOWAvsISU” into the hashtag 34.
When a post 28 includes “I hope everyone evacuates, this one is going to be bad! #HurricaneMadeline” the content 30 is “I hope everyone evacuates, this one is going to be bad!”, the topic 32 is “Hurricane Madeline” and “#” is the hashtag 34, or alternatively when the pound symbol is presented in front of the unspaced topic 28 “HurricaneMadeline” this converts the entire text of “#HurricaneMadeline” into the hashtag 34.

While the social media platform 12 is effective at allowing users 18 to make posts 28 to the social media platform 12 as well as search and review what other uses 18 are discussing, the conventional social media platform 12 is essentially unable to effectively monetize the activity that occurs on the social media platform 12. The system 10 presented herein facilitates sponsors 38 to buy the rights to certain topics 32 or hashtags 34 to have a symbol auto-populated whenever a post 28 is published or viewed with the purchased topic 32 or hashtag 34.

Sponsor 38 may be any company, organization, group, cause or other entity that desires to promote a topic 32 or hashtag 34 by displaying a symbol, logo, trademark, picture or other information in association with a certain topic 32 or hashtag 34. Sponsors 38 may choose to promote topics 32 or hashtags 34 that are likely to reach users 18 that are potential customers of sponsor 38. As examples, sports apparel companies are likely to be a sponsor of sporting event related topics 32 or hashtags 34; insurance companies are likely to be a sponsor of catastrophe related topics 32 or hashtags 34 such as floods, hurricanes, tornados or earthquakes; charities or social advocacy groups are likely to be a sponsor of topics 32 or hashtags 34 that relate to their causes, and the like.

Symbol 40 may be any logo, trademark, image, picture, pictorial, link, animation, video, or any other information that sponsor 38 desires to display in association with topic 32 or hashtag 34. Symbol 40 may include an interactive hyperlink such that when a user 18 clicks on the hyperlink they are directed to a website or other information related to or chosen by sponsor 38. In one arrangement, the symbol 40 is a stagnant and stationary image, whereas in another arrangement the symbol 40 includes motion or action, such as a movable caricature or short cartoon or the like, that helps draw attention to the symbol 40.

Continuing with the examples above:
When athletic apparel maker Nike is the sponsor 38 of the topic 32 “Game Day” or the hashtag 34 “#GameDay”, whenever the following post 28 is submitted: “The Iowa State Cyclones are going to win today! #GameDay” the system 10 auto-populates the chosen symbol 40 of the sponsor 38 which is in this case the famous Nike Swoosh either before and/or after “#GameDay”. This symbol 40 may include a hyperlink to Nike's website or a Nike-related website, further information about Nike, such as an online store selling Nike apparel, or the like.
When auto maker Audi is the sponsor 38 of the topic “International Day of Peace” or the hashtag 34 “#InternationalDayofPeace”, whenever the following post 28 is submitted: “Nothing is more important than peace! #InternationalDayofPeace” the system 10 auto-populates the chosen symbol 40 of the sponsor 38 which is in this case the famous Audi logo either before and/or after “#InternationalDayofPeace”. This symbol 40 may include a hyperlink to Audi's website or an Audi-related website, further information about Audi, such the closest Audi dealer, or the like.
When farm equipment maker John Deere is the sponsor 38 of the topic “IOWA vs ISU” or the hashtag 34 “#IOWAvsISU”, whenever the following post 28 is submitted “#IOWAvsISU Iowa has no chance in this one!” the system 10 auto-populates the chosen symbol 40 of sponsor 38 which is in this case the famous John Deere logo either before and/or after “#IOWAvsISU”. This symbol 40 may include a hyperlink to John Deere's website or John Deere related website, further information about John Deere, such as the closest John Deere dealer, new offerings from John Deere, or the like.
When insurance company Nationwide is the sponsor 38 of the topic “Hurricane Madeline” or the hashtag 34 “#HurricaneMadeline”, whenever the following post 28 is submitted “I hope everyone evacuates, this one is going to be bad! #HurricaneMadeline” the system 10 auto-populates the chosen symbol 40 of sponsor 38 which is in this case the Nationwide logo either before and/or after “#HurricaneMadeline”. This symbol 40 may include a hyperlink to Nationwide's website or a Nationwide related website, further information about Nationwide such as approved insurance salespeople, a website providing information related to storm preparedness, a list of the closest hurricane shelters, or the like.

Countless other examples exist. In this way, the system 10 provides an aesthetically pleasing appearance because the logo provides color and/or an image to the content 30 of post 28. The system 10 also does not substantially distract from the content 30 of post 28 as the symbol 40 is small, subtle and fits within the text of content 30 or post 28. In addition, the system 10 provides utility to the user 18 as the symbol 40 includes a hyperlink to information that may be of interest to the user 18. The system 10 also does not distract or delay the user 18 when submitting a post 28 to the social media platform 12 as the system 10 auto-populates the symbol 40 in the post 28.

Pricing:

Sponsor 38 may pay for the promotion of topic 32 and/or hashtag 34 by any manner, method or means. In the simplest arrangement, sponsor 38 pays a set fee for each time the topic 32 or hashtag 34 is viewed. In one arrangement, sponsor 38 pays in the range of $0.14 to $0.28 per post 28 and/or view of post 28, the price depending on the number of posts 28 and views of the posts 28 (tweets, retweets, views, and impressions). Although any other price-per-post 28 is hereby contemplated for use from only a fraction of a penny to upwards of one, two, three or more dollars per post 28.

Alternatively, as an example, the sponsor 38 pays $0.09 USD each time the topic 32 or hashtag 34 is viewed. If the topic 32 or hashtag 34 is viewed a 500,000 times, then the sponsor 38 pays $0.09*500,000=$45,000.

In an alternative arrangement, a tiered system is used, wherein the sponsor 38 pays a tiered amount depending on the number of views. As an example, the sponsor pays: $0.09 USD per view for the 0 to 200,000 views, $0.08 USD per view for the views 200,001 to 400,000; $0.07 USD per view for the views 400,001 to 600,000; $0.06 USD per view for the views 400,001 to 600,000; $0.05 USD per view for the views 600,001 to 800,000; $0.04 USD per view for the views 600,001 to 800,000; $0.03 USD per view for the views 800,001 to 1,000,000; $0.02 USD per view for the views 1,000,001 to 1,200,000; $0.01 USD per view for the views 1,200,001 to 1,400,000; then every view after $1,400,001 is free.

In an alternative arrangement, sponsor 38 pays a flat fee, such as $50,000 to promote a topic 32 or hashtag 34 for a predetermined amount of time such as two weeks. In the event that the topic 32 or hashtag 34 is extremely popular, such as several million posts 28 during the promotion period, then the sponsor 38 has a very low cost-per display and gets a lot of exposure. If on the other hand, the topic 32 or hashtag 34 is not popular during the promotion period, the sponsor 38 pays a higher cost per display of the symbol 40.

In yet another arrangement, social media platform 12, or an associated marketing-firm 42, as is further described herein, may auction off sponsorship of a topic 32 or hashtag 34 to the highest bidder. In this way, using an auction-type price setting arrangement allows the market to set the price for the display of symbol 40 after hashtag 34.

Sponsor 38 may promote the topic 32 or hashtag 34 for a predetermined amount of time, a predetermined number of posts 28, a predetermined cost, or any other variable or consideration or any combination of these or other factors.

Some topics 32 and hashtags 34 are predictable. That is, topics 32 and hashtags 34 are predictable around certain events such as elections, presidential debates, big sporting events (such as big rivalry games, the Super Bowl, Daytona 500, March Madness, World Series, NBA Championships, the Stanley Cup, the Olympics, the Masters, a big boxing or MMA match, and the like), Federal Reserve meetings, earnings reports for publicly traded companies, Holidays, anniversaries of memorable events (such as Pearl Harbor, September 11^{th}, the assignation of Martin Luther King, Jr., and the like), the premier of a much anticipated movie, among countless other events. For these predictable events, sponsorship of these topics 32 and hashtags 34 can be arranged well in advance of the predictable spike in related posts 28.

Other events may not necessarily be scheduled, but they are somewhat predictable. As an example, while we may not know when the next hurricane will be, there will be another hurricane. As another example, while we may not know when the next flood will be, there will be another flood. As yet another example, while we may not know when the next winter blizzard will be, there will be another blizzard. For these events sponsorship can similarly be arranged ahead of time.

Other events are completely unpredictable, such as scandals, viral events, disasters, untimely deaths of famous people or the like.

Regardless whether a topic 32 or hashtag 34 is predictable, sponsorship of the topic 32 or hashtag 34 may begin at a predetermined date or time. Alternatively, sponsorship of the topic 32 or hashtag 34 may begin when a topic 32 or hashtag 34 meets or exceeds a predetermined threshold of activity, such as a number of posts 28 within a predetermined period of time.

Algorithm:

Sponsor 38 may purchase the right to promote exact topics 32 or hashtags 34 such that their chosen symbol 40 only appears after the exact topic 32 or hashtag 34 is included in a post 28. Alternatively, Sponsor 38 may purchase the right to promote topics 32 or hashtags 34 that include key words or phrases. This provides some flexibility and some expanded scope such that the sponsor 38 does not have to purchase the exact topic 32 or keyword 34. Using the example above, Nationwide can purchase all hashtags 34 and topics 32 that include the hashtag symbol “#” and the word “hurricane” such that when social media posts 28 include “#” and “hurricane” the Nationwide symbol 40 appears regardless of the other words or text in the post 28, such as in this example “Madeline”.

In one arrangement, system 10 includes an algorithm 42 that determines whether a topic 32 or hashtag 34 is sufficiently related to a purchased topic 32 or hashtag 34 to justify or qualify as a sponsored topic 32 or hashtag 34 and therefore have symbol 40 displayed with the topic 32 or hashtag 34. The use of algorithm 42 can also help prevent the sponsorship of a negative topic 32 or hashtag 34 from being sponsored. As an example, while Nike may purchase the right to sponsor or promote topics 32 or hashtags 34 that include the term “Super Bowl” algorithm may determine that a post that includes “#IHateTheSuperBowl” is negative and therefore does not qualify to be sponsored. The algorithm 42 may also take into account the words, phrases or statements in the content 30 of the post 28 to determine whether the post 28 is negative, disparaging, slanderous, or otherwise distasteful and if so disqualify that particular post 28 for sponsorship. In these ways, the use of algorithm 42 or keywords thus provides some flexibility and added protections to the system 10.

Marketing Firm:

In one arrangement, the social media company 11 itself markets the system 10 in-house and arranges for sponsorship of topics 32 or hashtags 34 by sponsors 38 and works directly with sponsors 38 to develop the appropriate symbol 40, determine the terms of sponsorship (such as price, length of time, when the sponsorship begins and ends) among other terms. The social media company 11 itself then develops the code to determine when a post 28 qualifies for sponsorship and then displays the symbol 40 in association with each qualifying post 28 that includes topic 32 or hashtag 34 during the term of sponsorship. In this arrangement, social media company 11 keeps all of the fees collected from sponsors 38.

In an alternative arrangement, social media company 11 works in association with a third-party marketing firm 44. In this arrangement, marketing firm 44 seeks sponsors 38 for topics 32 and hashtags 34 and works directly with sponsors 38 to develop the appropriate symbol 40, determine the terms of sponsorship (such as price, length of time, when the sponsorship begins and ends) among other terms. The marketing firm 44 then develops the code to determine when a post 28 qualifies for sponsorship and then provides information to social media platform 12 and/or social media company 11 when to display symbol 40 in association with a qualifying post 28 that includes topic 32 or hashtag 34 during the term of sponsorship. In this arrangement, the social media platform 12 and/or social media company 11 and marketing firm 44 split or share the fees collected from the sponsors 38 under terms of a separate agreement.

In one arrangement, a database 46 is established that includes a list of sponsored topics 32 or hashtags 34 and the associated code and/or symbol 40 that is to be displayed when a post 28 includes the sponsored topic 32 or hashtag 34. In this arrangement, when a post 28 is submitted by a user 18 to social media platform 12, social media platform 12 analyzes the content 30 of post 28 using algorithm 42 and determines what topics 32 or hashtags 34 are part of post 28. Once the topics 32 or hashtags 34 are determined, social media platform 12 reviews database 46 to determine if any of the topics 32 or hashtags 34 qualify for sponsorship under the system 10. If so, social media platform 12 retrieves the code or symbol 40 from database 46 and displays the symbol 40 in association with the topic 32 or hashtag 34 when viewers 48 view the post 28.

In Operation:

Utilizing the system 10 presented herein, social media platform 12 (or marketing firm 44) seek out sponsors 38 to promote various topics 32 or hashtags 34. The social media platform 12 and sponsor 38 come to terms of agreement related to the sponsorship such as the price of the sponsorship, what topics 32 or hashtags 34 are promoted, what symbol 40 will be, when the promotion starts, when the promotion stops, whether and how algorithm 42 is used to eliminate negative posts 28 or expand the scope of the promotion by keying off of a single term, any disqualifying factors, whether a hyperlink is included as part of the symbol 40, and any other salient points of agreement.

After the agreement has been made between sponsor 38 and social media platform 12 (or marketing firm 44) when a user 18 submits a post 28 to the social media platform 12, the social media platform 12 scans the content 30 of the post 28 using algorithm 42 to determine whether the post 28 includes one or more topics 32 or hashtags 34 therein. Social media platform 12 compares any topics 32 or hashtags 34 found in post 28 with database 46 to determine if these topics 32 or hashtags 34 are promoted. Social media platform 12 also uses algorithm 42 to determine if there are any disqualifying factors, keywords or other factors to consider. In the event that post 28 includes a topic 32 or hashtag 34 and no disqualifying factors, social media platform 12 retrieves symbol 40 from database 46 and when post 28 is published on social media platform 12, symbol 40 is displayed after, before, before and after, or in any other position or association with topic 32 or hashtag 34.

Emoji, Emoticon, Unicode Consortium:

An emoji is an ideogram or smiley used in an electronic message or on a Web page. Emoji are used much like emoticons and exist in various genres, including facial expressions, common objects, places and types of weather, and animals, to name a few.

An emoticon is a pictorial representation of a facial expression using punctuation marks, numbers and letters, usually written to express a person's feelings or mood. As social media has become widespread, emoticons have played a significant role in communication through technology, and some devices have provided stylized pictures that do not use punctuation. They offer another range of “tone” and feeling through texting that portrays specific emotions through facial gestures while in the midst of text-based cyber communication.

The Unicode Consortium is a non-profit corporation devoted to developing, maintaining, and promoting software internationalization standards and data, particularly the Unicode Standard, which specifies the representation of text in all modern software products and standards. The Unicode Consortium actively develops standards in the area of internationalization including defining the behavior and relationships between Unicode characters. The Consortium works closely with W3C and ISO—in particular with ISO/IEC/JTC 1/SC2/WG2, which is responsible for maintaining ISO/IEC 10646, the International Standard synchronized with the Unicode Standard.

In one arrangement, the system 10 includes development of a corporate emoji or emoticon that is recognized by the Unicode Consortium. This emoji or emoticon is used as symbol 40.

From the above discussion and the accompanying drawings and claims it will be appreciated that the social media advertising system and method: improves upon the state of the art; is easy to use; advertisers and users like; is subtle but effective; does not distract from the content or purpose of the social media platform; is easy to implement; increases revenues; is aesthetically pleasing; provides further information regarding the advertiser; helps to harness the power of social networks; is inexpensive; provides results; does not inconvenience the user; is easy to implement for the advertiser; provides value, utility and novelty, among countless other improvements and advantages.

It will be appreciated by those skilled in the art that other various modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in light thereof will be suggested to persons skilled in the art and are to be included within the spirit and purview of this application.

What is claimed:

1. A method of advertising on a social media platform, the steps comprising:
providing a social media platform by a social media company;
submitting a social media post related to a topic on the social media platform by a user;
associating the topic of the social media post with a sponsor by the social media company;
publishing the social media post related to a topic by the social media company on the social media platform;
displaying a symbol associated with the sponsor in association with the topic.

2. The system of claim 1 wherein the topic includes a hashtag.

3. The system of claim 1 wherein the topic begins with a hashtag.

4. The system of claim 1 wherein the symbol includes an interactive link to the sponsor or to a website or other content associated with the sponsor.

5. The system of claim 1 wherein the sponsor is charged a fee for the display of the symbol in association with the topic.

6. The system of claim 1 wherein the symbol is displayed before a hashtag or after a hashtag.

7. The system of claim 1 wherein the symbol is automatically displayed after the topic exceeds a predetermined number of views.

8. The system of claim 1 wherein the social media platform is Twitter, Facebook, Snap Chat, YouTube or Instagram.

9. The system of claim 1 wherein the symbol is a logo, trademark, name, web address, emoticon, or corporate emoticon.

10. A method of advertising on a social media platform, the steps comprising:
providing a social media platform by a social media company;
submitting social media posts related to a topic on the social media platform by users;
detecting when a topic has exceeded a predetermined threshold;
associating the topic with a sponsor;
displaying a symbol of the sponsor in association with the topic.

11. The system of claim 10 wherein the topic includes a hashtag.

12. The system of claim 10 wherein the topic begins with a hashtag.

13. The system of claim 10 wherein the symbol includes an interactive link to the sponsor or to a website or other content associated with the sponsor.

14. The system of claim 10 wherein the sponsor is charged a fee for the display of the symbol in association with the topic by the social media company.

15. The system of claim 10 wherein the logo is displayed before a hashtag or after a hashtag.

16. The system of claim 10 wherein the logo is automatically displayed after the topic exceeds a predetermined number of views.

17. The system of claim 10 wherein the social media platform is Twitter, Facebook, Snap Chat, YouTube or Instagram.

18. The system of claim 10 wherein the symbol is a logo, trademark, name, web address, emoticon, or corporate emoticon.

19. A method of advertising on a social media platform, the steps comprising:
providing a social media platform by a social media company;
submitting a social media post on the social media platform by a user, the social media post having content, a hashtag and a topic;
associating the topic of the social media post with a sponsor by the social media company;
publishing the social media post having content, a hashtag and a topic by the social media company on the social media platform;
displaying a symbol associated with the sponsor in the social media post after the hashtag and the topic.

20. The system of claim 19 wherein the symbol is a logo, trademark, name, web address, emoticon, or corporate emoticon.
